(19) United States
(12) Patent Application Publication
(10) Pub. No.: US 2026/0180932 A1
(43) Pub. Date: Jun. 25, 2026

(54) INFORMATION PROCESSING SYSTEM, INFORMATION PROCESSING METHOD AND TERMINAL

(71) Applicant: Rie KOBAYASHI, Tokyo (JP)

(72) Inventor: Rie KOBAYASHI, Tokyo (JP)

(21) Appl. No.: 19/424,580

(22) Filed: Dec. 18, 2025

(30) Foreign Application Priority Data
Dec. 19, 2024 (JP) 2024-223677
Sep. 30, 2025 (JP) 2025-163293

(51) Int. Cl. H04L 51/02; G06F 3/0482; G06F 3/0483

(52) U.S. Cl. CPC H04L 51/02; G06F 3/0482; G06F 3/0483

(57) ABSTRACT

Different conversational Artificial Intelligence agents may output different results and/or have access to different data and/or be subject to different training. A user can be provided with the AI agent which provides the most suitable, best, or desired results. There are a plurality of conversational AIs and the most suitable one or more conversational AI can be selected automatically. The user selects one conversational AI manually form the one or more conversational AI. A display may indicate which of the plurality of conversational Als is being used. If desired, information can be transmitted and presented based on web pages and HTTP requests.

### CROSS-REFERENCE TO RELATED APPLICATIONS

This patent application is based on and claims priority pursuant to 35 U.S.C. § 119 (a) to Japanese Patent Application Nos. 2024-223677, filed on Dec. 19, 2024, and 2025-163293, filed on Sep. 30, 2025, in the Japan Patent Office, the entire disclosure of each of which is hereby incorporated by reference herein.

### BACKGROUND

### Technical Field

The present disclosure relates to an information processing system, an information processing method, and a terminal.

### Related Art

Conventionally, computer systems have been devised that engage in conversation with users by automatically generating responses using AI (Artificial Intelligence) to messages such as questions from users and outputting the responses.

### SUMMARY

The present disclosure described herein includes an information processing system comprising an information processing apparatus and a terminal. The information processing apparatus comprises first circuitry that transmit web content data to the terminal, the web content data including (i) data for causing a display of a first web page for accepting input of a message from a user, (ii) data for causing display of a second web page including one or more conversational AI, (iii) a first script which causes the terminal to transmit the message input in the first web page to the information processing apparatus, and (iv) a second script which causes the terminal to display information indicating the one or more conversational AI; selects the one or more conversational AI as a candidate for generating a response to the message from among a plurality of conversational AIs in response to receiving a Hypertext Transfer Protocol (HTTP) request including the message transmitted from the terminal in response to execution of the first script; and transmits an HTTP response including the information indicating the one or more conversational AI to the terminal. The terminal includes second circuitry that receives the web content data from the information processing apparatus before the execution of the first script, the web content data including (i) the data for causing the display of the first web page for accepting input of the message from the user, (ii) the data for causing the display of the second web page including the one or more conversational AI, (iii) the first script which causes the terminal to transmit the message input in the first web page to the information processing apparatus, and (iv) the second script which causes the terminal to display information indicating the one or more conversational AI; displays the first web page for accepting input of the message from the user based on the web content data; receives the message from the user via the first web page; transmits the HTTP request including the message in response to executing the first script included in the web content data; receives the HTTP response including the information indicating the one or more conversational AI from the information processing apparatus; and displays the second web page including the one or more conversational AI based on the web content data in response to executing the second script.

The present disclosure described herein provides an information processing method comprising transmitting web content data to a terminal before execution of a first script on a terminal, the web content data including (i) data for causing a display of a first web page for accepting input of a message from a user, (ii) data for causing display of a second web page including one or more conversational AI, (iii) the first script which causes the terminal to transmit the message input in the first web page to the information processing apparatus, and (iv) a second script which causes the terminal to display information indicating the one or more conversational AI; selecting the one or more conversational AI as a candidate for generating a response to the message from among a plurality of conversational Als in response to receiving a Hypertext Transfer Protocol (HTTP) request including the message transmitted from the terminal in response to the execution of the first script; and transmitting an HTTP response including the information indicating the one or more conversational AI to the terminal.

The present disclosure described herein provides a terminal comprising circuitry that displays a first web page for accepting input of a message from a user; receives the message input by the user; selects one or more conversational AI as a candidate for generating a response to the message from among a plurality of conversational Als in response to receiving the message; displays a second web page including the one or more conversational AI.

### BRIEF DESCRIPTION OF THE DRAWINGS

FIG. 1 is a diagram illustrating a configuration of the information processing system of the first embodiment.

FIG. 2 is a diagram illustrating a hardware configuration of the information processing apparatus 10 of the first embodiment.

FIG. 3 is a diagram illustrating a functional configuration of the information processing system related to the document registration phase of the first embodiment.

FIG. 4 is a sequence diagram illustrating processing steps in the document registration phase.

FIG. 5 is a diagram illustrating a summary storage unit 143.

FIG. 6 is a diagram illustrating a functional configuration of the information processing system related to the conversation phase of the first embodiment.

FIG. 7 is a sequence diagram illustrating processing steps for the conversation phase.

FIG. 8 is a sequence diagram illustrating processing steps for the conversation phase.

FIG. 9 is a diagram illustrating a display of an interactive screen at the start of conversation.

FIG. 10 is a diagram illustrating a display of the interactive screen containing a list of response candidates.

FIG. 11 is a diagram illustrating a response display.

FIG. 12 is a diagram illustrating of a confirmation information display.

FIG. 13 is a diagram illustrating a display for the selected agent.

FIG. 14 is a diagram illustrating a functional configuration of the terminal 20 of the fourth embodiment.

FIG. 15 is a sequence diagram illustrating a processing procedure for screen transitions of the fourth embodiment.

FIG. 16 is a diagram illustrating a display of the interactive screen 510 after message input.

FIG. 17 is a diagram illustrating a functional configuration of the terminal 20 equipped with the functions of the information processing apparatus 10.

### DETAILED DESCRIPTION

The disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise. The term “connected/coupled” includes both direct connections and connections in which there are one or more intermediate connecting elements. For the sake of simplicity, identical or similar reference numerals denote identical or similar elements such as parts and materials having the same functions, and redundant descriptions thereof are omitted unless otherwise required.

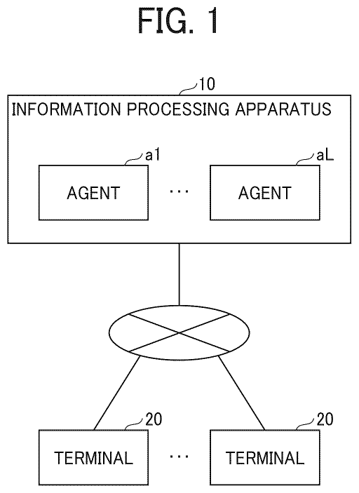

The following describes embodiments of the present disclosure based on the drawings. FIG. 1 is a diagram showing an example configuration of the information processing system in the first embodiment. In FIG. 1, one or more terminals 20 connect to the information processing apparatus 10 via a network such as a LAN (Local Area Network) or the Internet.

The information processing apparatus 10 is one or more computers functioning as multiple types of conversational AI (Artificial Intelligence) that interact with users using AI. The conversational AI is a personified virtual entity that appears to the user as an interlocutor which takes part in a dialogue or conversation. An interlocutor is, for example, a partner of the dialogue or conversation. Conversation with the conversational AI (interlocutor) includes a situation where, when the user inputs a message, a response to it is output.

Specifically, the conversational AI receives messages input by the user from terminal 20. The conversational AI searches within a collection of document data pre-registered with information processing apparatus 10 for document data with relatively high similarity to the received message. The conversational AI controls the generation of a response to the message based on the retrieved document data and outputs the response to terminal 20. The message input by the user may be a question, an instruction or request, or other input information requiring a response. The response is text containing information corresponding to the message. The response may also be output as audio.

In this embodiment, the conversational AI is referred to as an agent. However, the conversational AI may also be called an AI agent, digital clone, personalized AI, AI assistant, automated response AI, conversation partner, AI chatbot, companion, concierge, or virtual conversational interface. The agent may be a virtual human displayed on a screen of the terminal 20 as a 3D avatar modeled after a person, serving as a conversation partner.

In this embodiment, the multiple types of agents are distinguished by a difference in data sources referenced to generate responses to messages from the user. Data sources refer to collections of document data. For example, each data source is a collection of document data related to mutually different fields. That is, for the same message, each agent searches for document data related to that message from mutually distinct data sources. The response corresponding to the message is generated based on the searched document data. Therefore, for the same message, each agent generates a different response.

A user can select one agent suitable for their purpose or application from among the multiple types of agents as a conversation partner. To assist the user in selecting an agent, the information processing apparatus 10 selects some agents capable of generating a more appropriate response to the message input by the user and presents (recommends) these selected agents to the user as response candidates.

Terminal 20 is a device functioning as a user interface for the information processing system. For example, a PC (Personal Computer), smartphone, or tablet may be used as terminal 20. Terminal 20 accepts message input from the user and transmits the message to information processing apparatus 10. Terminal 20 also receives and displays the response generated by information processing apparatus 10 for that message.

In this embodiment, the information processing apparatus is assumed to be operated within a certain company (hereinafter referred to as “Company X”). Therefore, users who can access the information processing apparatus 10 are individuals belonging to Company X, such as its employees. The services provided by the information processing apparatus 10 may be publicly available like, for example, cloud services.

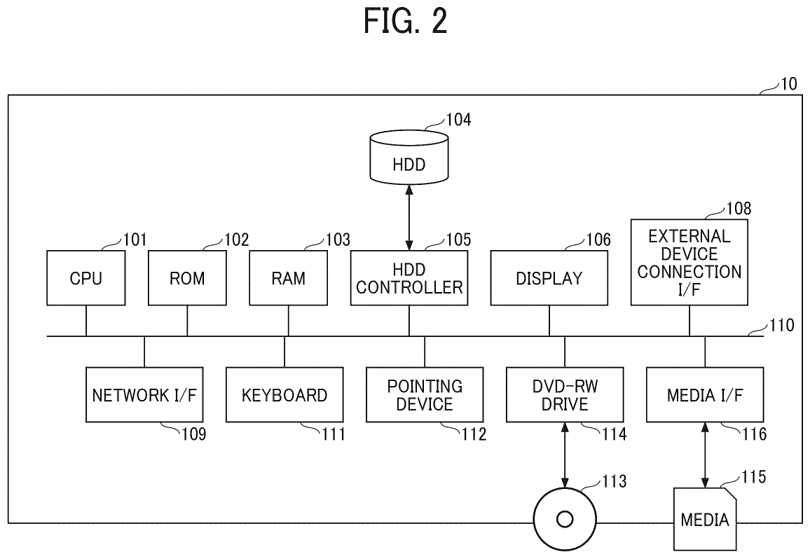

FIG. 2 is a diagram showing an example of the hardware configuration of the information processing apparatus 10 in the first embodiment. As shown in FIG. 2, the information processing apparatus 10 is, for example, a computer that includes a CPU 101 (Central Processing Unit), a ROM 102 (Read Only Memory), a RAM (Random Access Memory) 103, an HDD (Hard Disk Drive) 104, an HDD (Hard Disk Drive) controller 105, a display 106, an external device connection I/F (Interface) 108, a network I/F 109, a data bus 110, a keyboard 111, a pointing device 112, a DVD-RW (Digital Versatile Disk Rewritable) drive 114, and a media I/F 116.

The CPU 101 controls the operation of the entire information processing apparatus 10. The ROM 102 stores programs used to drive the CPU 101, such as an IPL (Initial Program Loader). The RAM 103 is used as the work area for the CPU 101. The HDD 104 stores various data such as programs. The HDD controller 105 controls reading and writing of various data to the HDD 104 according to the control of the CPU 101. The display 106 displays various information such as cursors, menus, windows, characters, or images. The external device connection I/F 108 is an interface for connecting various external devices. In this case, the external devices include, for example, a USB (Universal Serial Bus) memory and printers. The network I/F 109 is an interface for data communication using a communication network. The data bus 110 is an address bus or data bus, etc., for electrically connecting various components such as the CPU 101.

The keyboard 111 is a type of input device equipped with multiple keys for inputting characters, numerals, and various instructions. The pointing device 112 is a type of input device used for selecting and executing various instructions, selecting processing targets, moving the cursor, etc. The DVD-RW drive 114 controls the reading and writing of various data to a DVD-RW 113, an example of a removable recording medium. Note that the DVD-RW is not limited to DVD-RW; it may also be DVD-R, etc. The media I/F 116 controls the reading and writing (storage) of data to and from a recording medium 115, such as flash memory.

The following describes the functional configuration of the information processing apparatus 10 and the details of the processing steps executed by the information processing apparatus 10. In this embodiment, the processing steps executed by the information processing apparatus 10 are described in two phases, a phase for registering document data with the information processing apparatus 10 (hereinafter referred to as the “document registration phase”) and a phase for interacting with the user using the document data registered with the information processing apparatus 10 (or its agent) (hereinafter referred to as the “conversation phase”).

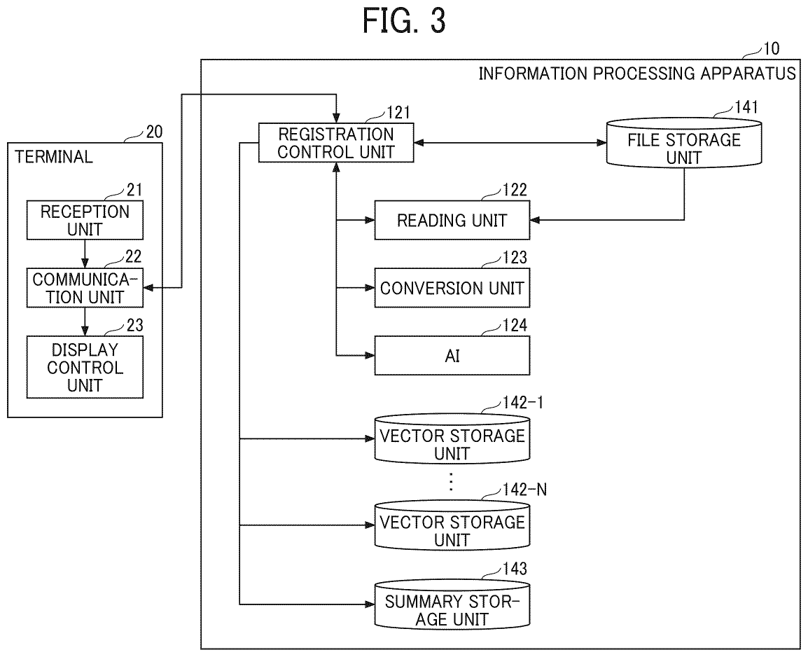

First, the document registration phase will be described. FIG. 3 is an example of the functional configuration of an information processing system related to the document registration phase in the first embodiment. In FIG. 3, the information processing apparatus 10 has a registration control unit 121, a reading unit 122, a conversion unit 123, and an AI 124. Each of these units is realized by processing executed by the CPU 101 via one or more programs installed in the information processing apparatus 10. The information processing apparatus 10 also utilizes storage units such as a file storage unit 141, vector storage units 142-1 to N, and a summary storage unit 143. Each of these storage units may be implemented, for example, using storage devices such as the HDD 104 or storage devices connectable to the information processing apparatus 10 via a network.

The file storage unit 141 stores files (hereinafter referred to as “document files”) containing document data designated for registration by the information processing apparatus 10. Document files are uploaded from the terminal 20 to the file storage unit 141. Registration control unit 121 controls the processing steps related to the document registration phase for the document data stored in the document files uploaded to file storage unit 141. The reading unit 122 converts the document data into text. That is, the reading unit 122 generates text data (hereinafter referred to as “document text”) indicating the content of the document files, which is the content of the document data. The method of text conversion varies depending on a data format of the document data. For example, in a case of a target document data in an image format, text conversion may be performed using OCR (Optical Character Recognition).

The conversion unit 123 converts each chunk of the document text into a vector (hereinafter referred to as a “semantic vector”) that represents a semantic content of that chunk as multidimensional numerical values. The semantic vector can be generated using natural language processing techniques such as BERT (Bidirectional Encoder Representations from Transformers). A chunk of the document text refers to a portion of the document text obtained by dividing the document text into predetermined units.

A unit used for dividing the document text may be a number of characters, a number of sentences, or a semantic unit (e.g., a paragraph, etc.). The document text may be pre-divided and stored by the unit. Hereinafter, the semantic vector for each chunk is referred to as a “chunk vector.” The chunk vector for a chunk of a certain document data is registered in one of the vector storage units 142-1 to N (hereinafter collectively referred to as “vector storage unit 142” when no distinction is made). The specific vector storage unit 142-1 to N to which a chunk vector for a given document data is registered is specified by the user when the document file containing that document data is uploaded.

The conversion unit 123 also generates a vector representing a summary of the document data (hereinafter referred to as the “summarized vector”). In this embodiment, the summary of the document data is text data containing a summarized text of the document text of the document data. The summarized vector for each document data is registered in the summary storage unit 143.

The AI 124 is a machine learning model (e.g., a neural network) trained to generate text corresponding to input text (hereinafter referred to as a “prompt”). The AI 124 generates text with the highest probability of occurrence based on its training results in response to the prompt. For example, a generative AI using a large language model (LLM) is used as AI 124. The LLM is a machine learning model trained on natural language processing using vast amounts of text data. The LLMs are used for many NLP (Natural Language Processing) tasks, such as generating responses to specific questions, automatic text generation, text summarization, translation, and sentiment analysis. The LLMs can also be utilized for various applications including education, entertainment, customer service, and product development. Note that machine learning models other than LLMs can also be used as AI 124.

During the registration phase, the AI 124 is used to generate the summarized text of the document text. The information processing apparatus 10 may not necessarily possess the AI 124. In this case, an external generative AI that is publicly available, such as on the Internet, may be utilized as the AI 124.

The terminal 20 has a reception unit 21, a communication unit 22, and a display control unit 23. Each of these units is realized by processing executed by a CPU of the terminal 20 via a program installed on the terminal 20. The reception unit 21 receives user operations directed at the terminal 20. The communication unit 22 is a communication interface that controls communication with the information processing apparatus 10. The display control unit 23 controls the display of screens (e.g., an interactive screen 510 described later) based on information (display data) received from the information processing apparatus 10.

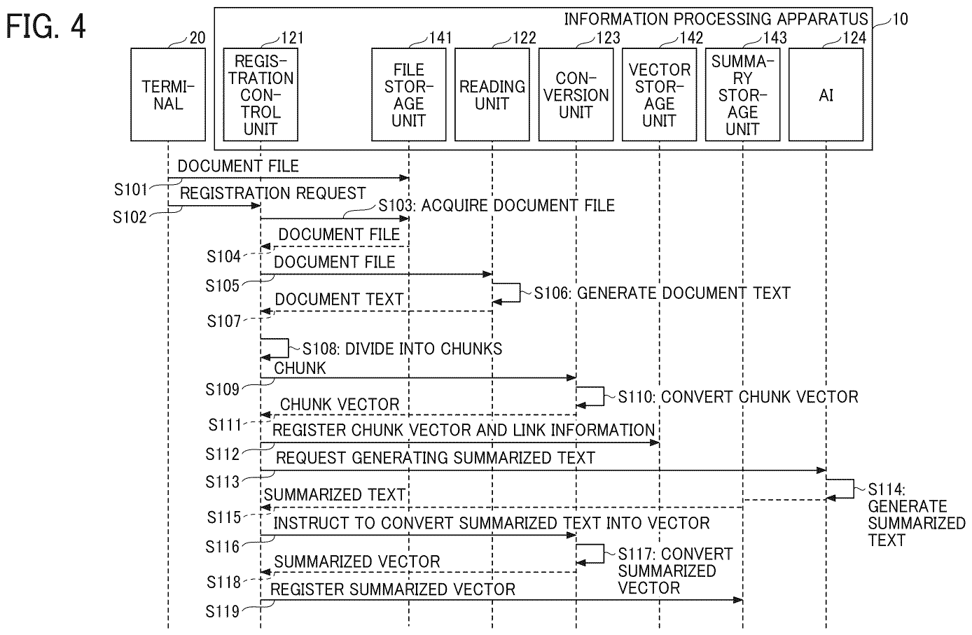

FIG. 4 is a sequence diagram illustrating an example processing procedure for the document registration phase. FIG. 4 is executed at a time chosen by the user. When the user wishes to register a certain document file with the data source of one of multiple types of agents, the user inputs an upload instruction for that document file (hereinafter referred to as the “target document file”) to the terminal 20. The terminal 20 responds to this upload instruction by uploading the target document file to the file storage unit 141 (S101).

Subsequently, the user specifies information (hereinafter referred to as “link information”) indicating an upload destination of the target document file (file path or URL, etc.) and an identification information of the agent where the subject document file is to be registered (hereinafter referred to as “agent ID”) to the terminal 20. By specifying this information, the user inputs registration instructions for the target document file to the terminal 20. The terminal 20, in response to input of the user, transmits a registration request containing the link information (hereinafter referred to as “target link information”) and the agent ID (hereinafter referred to as “target agent ID”) to the information processing device 10 (S102).

Upon receiving the registration request, the registration control unit 121 of the information processing apparatus 10 retrieves the target document file corresponding to the target link information included in the registration request from the file storage unit 141 (S103, S104). Next, the registration control unit 121 inputs the target document file to the reading unit 122 (S105). The reading unit 122 generates document text (hereinafter referred to as “target document text”) by converting the input target document file into text (S106). Subsequently, the reading unit 122 outputs the target document text to the registration control unit 121 (S107).

Next, the registration control unit 121 generates multiple chunks by segmenting the target document text (S108). Subsequently, the registration control unit 121 inputs all generated chunks to the conversion unit 123 (S109). The conversion unit 123 generates a chunk vector for each input chunk by converting the chunk into a semantic vector (S110). Next, the conversion unit 123 outputs the chunk vectors generated for each chunk to the registration control unit 121 (S111).

Next, the registration control unit 121 registers a record in the vector storage unit 142 corresponding to the target agent ID. This record contains identification information of the target document data (hereinafter referred to as the “document ID”) and, for each chunk of the target document data, an ID of that chunk (hereinafter referred to as the “chunk ID”), the chunk itself, the chunk vector generated by the conversion unit 123 for that chunk, and the target link information. For example, if the vector storage unit 142 corresponding to the target agent ID is vector storage unit 142-i, the record is registered in vector storage unit 142-i. Note that each vector storage unit 142 may be distinguished by folders, databases, or other management units for document data collections.

Next, the registration control unit 121 requests the AI 124 to generate the summarized text of the target document text (S113). This request may be made by inputting a prompt to the AI 124 that includes the target document text and an instruction to summarize the target document text. The AI 124 generates the summarized text of the target text based on its learned parameters (S114) and outputs the summarized text (hereinafter referred to as the “target summarized text”) to the registration control unit 121 (S115).

Next, the registration control unit 121 inputs text containing the target summarized text to the conversion unit 123 (S116). This text is, for example, text data indicating the target summarized text. The conversion unit 123 generates the summarized vector by converting the input text into a semantic vector (S117). Subsequently, the conversion unit 123 outputs this summarized vector (hereinafter referred to as the “target summarized vector”) to the registration control unit 121 (S118). Next, the registration control unit 121 registers the document ID of the target document data, the target summarized vector, metadata of the target document file (e.g., file name), and the target agent ID in the summary storage unit 143 in association with each other (S119).

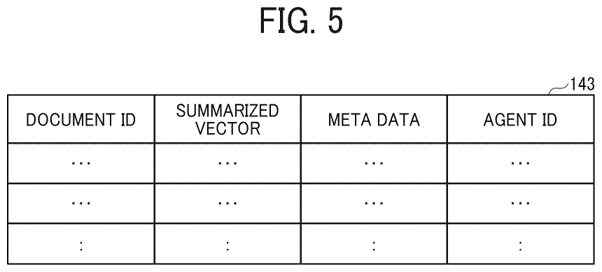

FIG. 5 is an example diagram of the summary storage unit 143. As shown in FIG. 5, the summary storage unit 143 stores summary information for each document data including the document ID, the summarized vector, the metadata, and the agent ID. By including the agent ID in the summary information, it is possible to distinguish which agent registered the summary information for which document data.

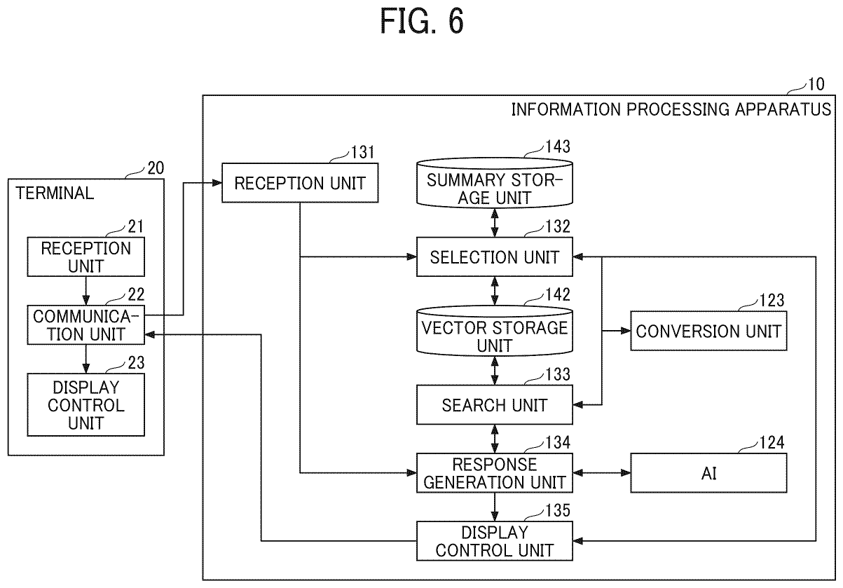

Next, the conversation phase will be described. FIG. 6 is a diagram illustrating the functional configuration of the information processing system regarding the conversation phase in the first embodiment. In FIG. 6, the same reference numerals as in FIG. 3 denote the same parts, and their descriptions are omitted as appropriate. In FIG. 6, the information processing apparatus includes a reception unit 131, a selection unit 132, a search unit 133, a conversion unit 123, a response generation unit 134, and a display control unit 135. These units are realized by processing executed by one or more programs installed in the information processing device 10 on the CPU 101.

The reception unit 131 receives input from the user. For example, the reception unit 131 receives input of the message for an agent. The reception unit 131 also receives a selection of one or more agents from the user, selected as candidates (hereinafter referred to as “response candidates”) to generate a response to the message from among the multiple types of agents. The user input is made to the terminal 20. Therefore, the reception unit 131 receives information corresponding to the input accepted by the terminal 20 from the terminal 20. When the reception unit 131 receives the message, the selection unit 132 selects the one or more agents from among the multiple types of agents that are candidates for generating the response to the message (response candidates) based on the message.

The search unit 133, based on the message received by the reception unit 131, references the vector storage unit 142 to extract a subset of document data having relatively high relevance to the message. Relatively high relevance to the message means that a similarity in semantic content to the message is relatively high. The response generation unit 134 controls the generation of the response to the message received by the reception unit 131 based on a set of similar chunks related to the search results from the search unit 133. Specifically, the response generation unit 134 generates a prompt by applying a system prompt to both the message and the search results.

Specifically, the selection unit 132 selects the one or more agents from among the multiple types of agents that is a candidate for generating the response to the message based on the similarity between the message and the set of document data (data source) corresponding to each agent. At this time, the selection unit calculates the similarity between the summarized vector registered in the summary storage unit 143 for each data source and the message vector of the message and evaluates the similarity between the set of document data (data source) corresponding to each agent and the message.

The search unit 133 searches for the document data associated with the chunk vector similar to a semantic vector of the message (hereinafter referred to as the “message vector”) received by the reception unit 131 from the vector storage unit 142 corresponding to the one or more agents associated with the response candidate selected by the user from among the response candidates selected by the selection unit 132.

The document data search performed by the search unit 133 is described in detail below. For each document data item in the vector storage unit 142 targeted for search, the search unit 133 calculates the similarity between the message vector and the chunk vector of each chunk associated with that document data. The search unit 133 then identifies the chunk (hereinafter referred to as the “similar chunk”) associated with the chunk vector exhibiting the highest similarity with respect to that document data. The search unit 133 compares similarity scores of the similar chunks for each document data and extracts the top N (N being an integer) similar chunks with the highest similarity scores. Consequently, N document data are extracted.

For evaluating the similarity between vectors, a cosine similarity may be used or other metrics may be employed. In this embodiment, a high similarity score indicates a high similarity between the message and the content of the document data. Search unit 133 includes in the search result the top N similar chunks, the chunk IDs stored in the vector storage unit 142 corresponding to these similar chunks, and the document IDs and the link information stored in the vector storage unit 142 corresponding to the document data to which these similar chunks belong (hereinafter referred to as “related document information”).

The response generation unit 134 generates the prompt including the similar chunks related to the search results obtained by the search unit 133. The prompt instructs the reception unit 131 to generate the response to the message based on the set of the similar chunks. The manner of including the set of the similar chunks related to the search results in the prompt may be the same as in a known RAG (Retrieval Augmented Generation). The text of each chunk belonging to the set of similar chunks related to the search results may be included in the prompt, or a vector generated based on the chunk vector of the chunk may be included in the prompt.

An example of a simplified prompt is as follows.

### Example of System Prompt Starts Here

The message from the user is as follows.

{Message}

Please generate a response to the message using the following documents as reference.

Set of Similar Chunks Related to Search Results}

### End of System Prompt Example

The response generation unit 134 sends the generated prompt to the AI 124 and receives the response generated by the AI 124 based on that prompt.

As described above, the system prompt defines a section for applying the message and a section for applying the set of similar chunks related to the search results from the search unit 133. In this case, the response generation unit 134 applies the message received by the reception unit 131 to the {Message} section of the system prompt and applies the set of similar chunks related to the search results from the search unit 133 to the {Set of similar chunks related to search results} section to generate the prompt.

By inputting the prompt generated in this manner to the AI 124, the AI 124 can generate a response utilizing knowledge (knowledge not yet learned by the AI 124) contained within the set of similar chunks related to the search results. That is, the response from the AI 124 can be based on the set of similar chunks related to the search results. The system prompt may include a string to notify the AI 124 of the agent's role corresponding to the system prompt, such as “You are XXX.” (where XXX is a string indicating the role).

The display control unit 135 displays a screen on the terminal 20 that accepts message input from the user at the start of the conversation phase, when the agent with which the user will interact has not yet been selected. The display control unit 135 also displays information indicating the one or more response candidates selected by the selection unit 132 on the terminal 20 when message input is received via the screen. That is, the display control unit 135 displays information indicating the one or more agents in response to message input for this screen.

The display control unit 135 further displays the response from the selected response candidate (agent) among one or more response candidates to terminal 20. The response from the selected response candidate (agent) is a response based on the data source (collection of document data) corresponding to that agent. The display control unit 135 specifically transmits display content to be displayed on the terminal 20's screen to the terminal 20. The terminal 20 displays the screen based on the display content using a browser.

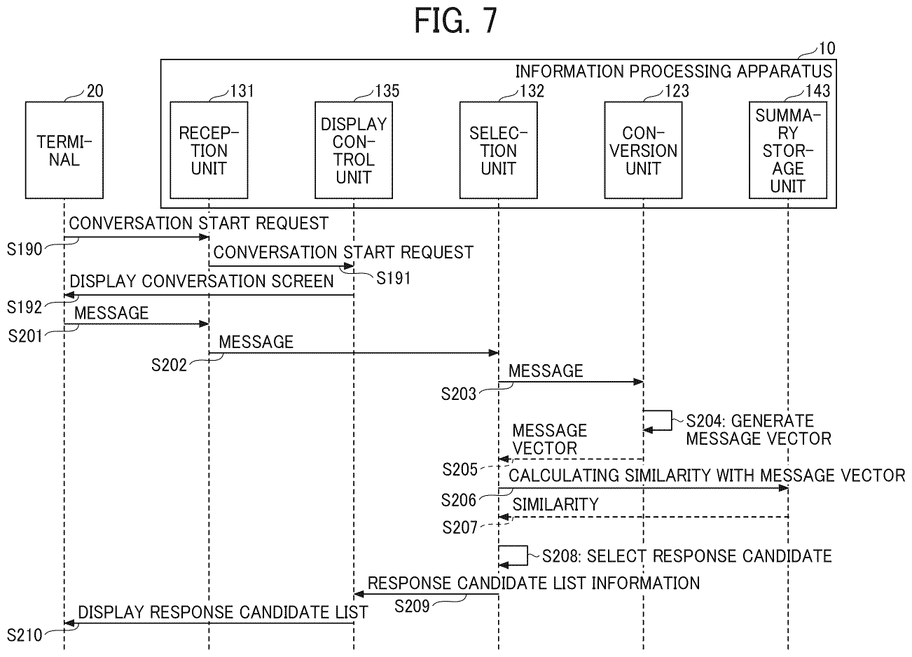

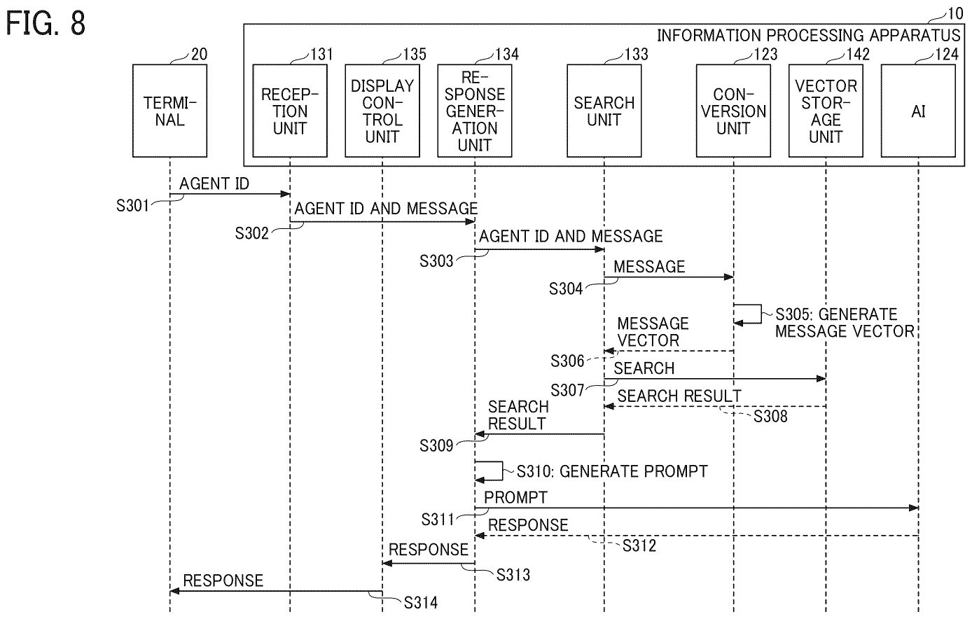

FIGS. 7 and 8 are sequence diagrams illustrating an example of the processing steps in the conversation phase. In step S190, when the user inputs an instruction to start the conversation into the terminal 20, the terminal 20 sends a conversation start request to the information processing apparatus 10. The reception unit 131 of the information processing apparatus 10 notifies the display control unit 135 of this start request (S191). The display control unit 135, in response to this request, displays an interactive screen on the terminal 20. This screen accepts message input from the user and facilitates conversation between the user and the agent (S192).

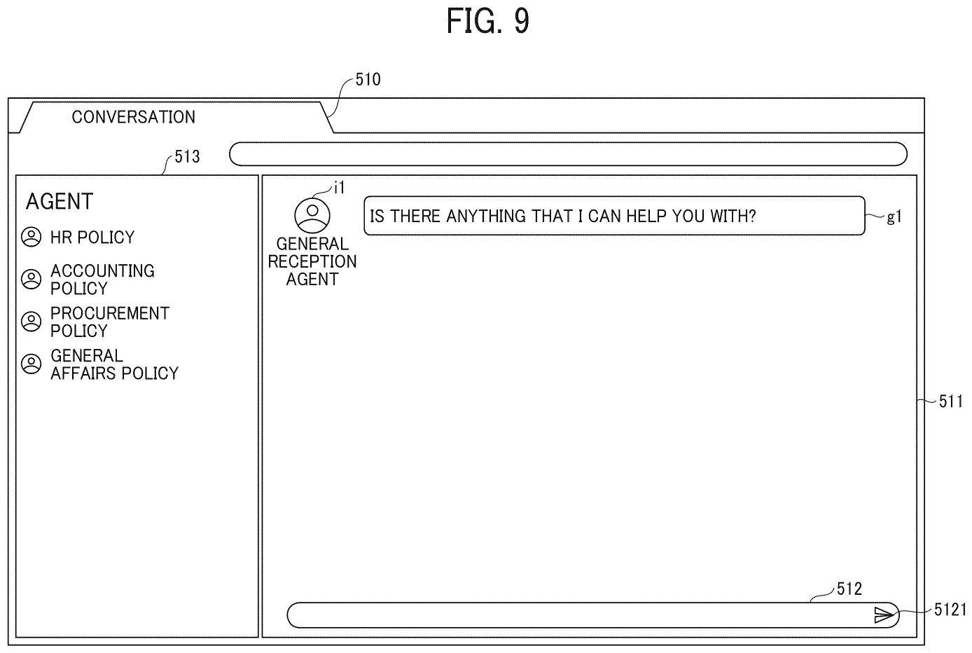

FIG. 9 is an example of the dialogue screen displayed at the start of conversation. The interactive screen 510 shown in FIG. 9 includes a conversation display area 511, a message input area 512, and an agent list area 513. The conversation display area 511 is the area where the content of the conversation between the agent and the user is displayed.

In the initial state, a greeting message g1 (“Is there anything that I can help you with in your work?”) prompting the user to input a message is displayed in the conversation display area 511. To the left of the greeting message g1, an agent icon i1 is displayed. At the start of the conversation, the interactive screen 510 shows the state where the user has not yet selected the agent to interact with. The greeting message g1 displayed in this state may be understood as a greeting from the agent acting as the general reception (hereinafter referred to as the “general reception agent”). The general reception agent conducts the conversation with the user based on the user's message until the agent is selected. The message input area 512 is an area for receiving message input from the user and includes a send icon 5121. The agent list area 513 is an area displaying a list of agent names that may be response candidates.

FIG. 9 shows an example displaying agents that differ by type of policy within Company X, such as “HR policy,” “Accounting policy,” “Procurement policy,” and “General Affairs policy.” “HR policy” refers to a collection of document data including, for example, allowance payment standards, handling of working hours and travel time during business trips, and special rules for overseas travel. “Accounting policy” refers to a collection of document data including, for example, methods for travel expense reimbursement, handling of receipts, and methods for calculating exchange rates. “Procurement Policy” refers to a collection of the document data that includes, for example, payment procedures for purchasing tickets, purchasing approval workflows, etc. “General Affairs policy” refer to a collection of the document data that includes, for example, business site operational management, company vehicle usage rules, emergency response and safety management, etc. Each agent corresponding to one of these policies can interact with users as an expert regarding the corresponding collection of the document data (“HR policy,” “Accounting Regulations,” “Procurement Policy,” or “General Affairs policy”).

When the user inputs the message into the message input area and clicks the send icon 5121, the terminal 20 sends that message (hereinafter referred to as the “target message”) to the information processing apparatus 10 (FIG. 7, S201). Upon receiving the target message, the reception unit 131 inputs the target message to the selection unit 132 (S202). The selection unit 132 inputs the target message to the conversion unit 123 (S203). The conversion unit 123 generates the message vector by converting the input target message into the semantic vector (S204). Subsequently, the conversion unit 123 outputs the message vector (hereinafter referred to as the “target message vector”) to the selection unit 132 (S205).

Next, the selection unit 132 calculates the similarity (e.g., cosine similarity) between the summarized vector contained in the summary information stored for each document data in the summary storage unit 143 (FIG. 5) and the target message vector (S206, S207). Subsequently, the selection unit 132 selects one or more agents from among the multiple types of agents as a response candidate based on the similarity between the summarized vector and the target message vector for each summary information (i.e., for each document data) (S208). For example, the selection unit 132 obtains the highest score of similarity between the summarized vector and the target message vector as a comparison index for each summary information sharing a common agent ID.

Therefore, the comparison index is obtained for each agent. The selection unit 132 selects the one or more agents from among the multiple types of agents associated with a portion of the summary information having a relatively high comparison index (e.g., similarity among the top M items, M being an integer) as a response candidate. It should be noted that instead of the maximum similarity score, an average similarity score may be obtained as the comparison index for each summary information with the common agent ID. Alternatively, the average of the top portion of the similarity scores may be obtained as the comparison index. As long as the index is based on the similarity, the comparison index may be obtained by other methods. Steps S206 to S208 (i.e., the selection of response candidates) may be executed using machine learning models such as the generative AI.

Next, the selection unit 132 outputs response candidate list information, including the agent ID and similarity, for each agent selected as the response candidate to the display control unit 135 (S209). Next, the display control unit 135 displays the response candidate list information on the terminal 20 (S210). For example, the display control unit 135 reflects the response candidate list information on the interactive screen 510 (FIG. 9). Specifically, the display control unit 135 generates display data for the interactive screen 510 containing the response candidate list information and transmits this display data to the terminal 20 to display the generated screen.

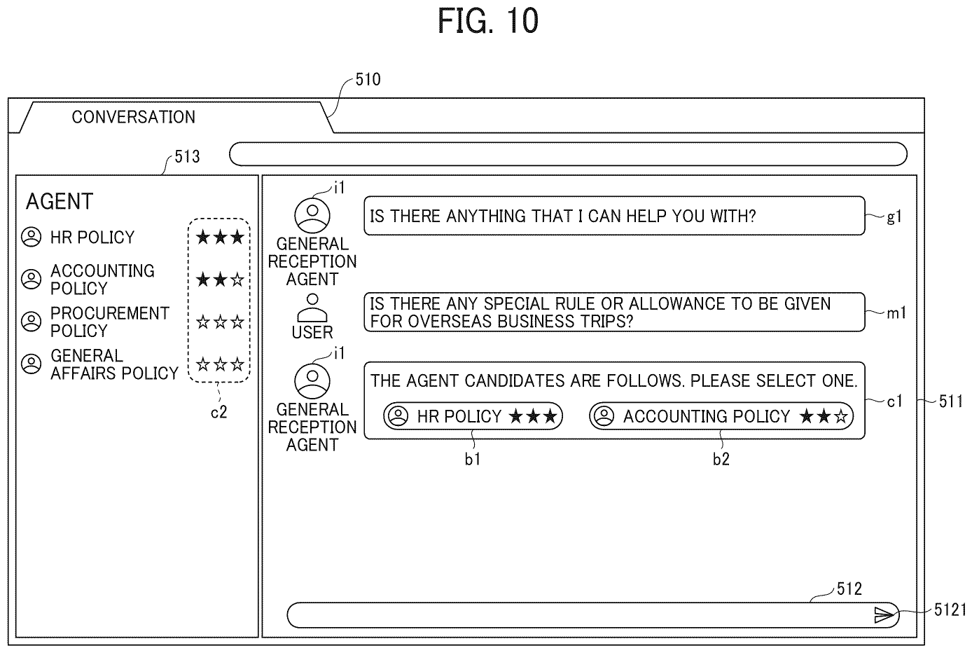

FIG. 10 is a diagram showing an example display of an interactive screen containing the response candidate list information. In FIG. 10, identical reference numerals are used for identical parts as in FIG. 9, and their descriptions are omitted. In the interactive screen 510 shown in FIG. 10, a message ml, display contents c1, and c2 have been added. The message ml is the target message entered by the user in the message input area 512 during step S201. When the user clicks the send icon 5121, the target message entered in the message input area 512 is displayed in the conversation display area 511.

The display contents c1 and c2 are display contents added during step S210. The content c2 includes a graphic representing the comparison index for each agent (e.g., the maximum similarity score between the summarized vector and the target message vector). A higher number of black-filled stars indicates a higher comparison index. Furthermore, a relatively high comparison index may be expressed by changing the display style, such as the color of the agent's name or the font of the tag.

The comparison index can also be considered a value indicating relevance of the response candidates to the target message. Therefore, when displaying information indicating the one or more selected response candidates, the display control unit 135 uses display content c2, etc., to display the relevance of the one or more response candidates to the target message in a manner that allows identification.

The display content c1 includes text indicating the agent selected as a response candidate and one or more button for selecting one of the response candidates from among the response candidates. FIG. 10 shows an example where the “HR policy” agent and the “Accounting policy” agent are selected as response candidates for the message ml, “Is there any special rule or allowance to be given for overseas business trips?” Therefore, the display content c1 includes a button b1 corresponding to the “HR policy” agent and a button b2 corresponding to the “Accounting policy” agent.

When the user selects either the button b1 or the button b2, the process proceeds to the steps in FIG. 8. Based on the user's selection, the terminal 20 transmits the agent ID (hereinafter referred to as the “selected agent ID”) of the agent corresponding to the selected button to the information processing apparatus 10 (S301 in FIG. 8). Upon receiving the selected agent ID, the reception unit 131 of the information processing apparatus 10 inputs the selected agent ID and the target message received in step S201 into the response generation unit 134 (S302). The response generation unit 134 inputs the selected agent ID and the target message to the search unit 133 (S303).

The search unit 133 inputs the target message to the conversion unit 123 (S304). The conversion unit 123 generates the message vector by converting the input target message into the semantic vector (S305). Subsequently, the conversion unit 123 outputs the message vector (hereinafter referred to as the “target message vector”) and the target message to the search unit 133 (S306). The search unit 133 performs a search based on the target message vector against the vector storage unit 142 corresponding to the selected agent ID input in step S303, thereby obtaining a search result (S307, S308). Specifically, the search unit 133 searches for the chunk vector corresponding to the selected agent ID in the vector storage unit 142.

Specifically, the search unit 133 compares the chunk vectors and message vectors stored in the vector storage unit 142 corresponding to the selected agent ID, both per document data and per chunk, thereby identifying the similar chunks for each document data. The search unit 133 then extracts a portion (top N items) of similar chunks with relatively high similarity to the target message. The search unit 133 generates a search result containing the related document information for each extracted similar chunk. Subsequently, the search unit 133 outputs the search result to the response generate unit 134 (S309).

The response generation unit 134 generates the prompt by applying the search result and the target message to the system prompt (S310). Subsequently, the response generation unit 134 sends the prompt to the AI 124 (S311). The response generation unit 134 receives the response generated by the AI 124, which accepted the prompt as input, from the AI 124 (S312). Next, the response generation unit 134 outputs the response (hereinafter referred to as the “target response”) to the display control unit 135 (S313).

The display control unit 135 causes the target response to be displayed on the interactive screen 510 displayed on the terminal 20 (S314). Specifically, the display control unit 135 generates display data for the interactive screen 510 containing the target response and transmits the generated screen data to the terminal 20 to display the screen.

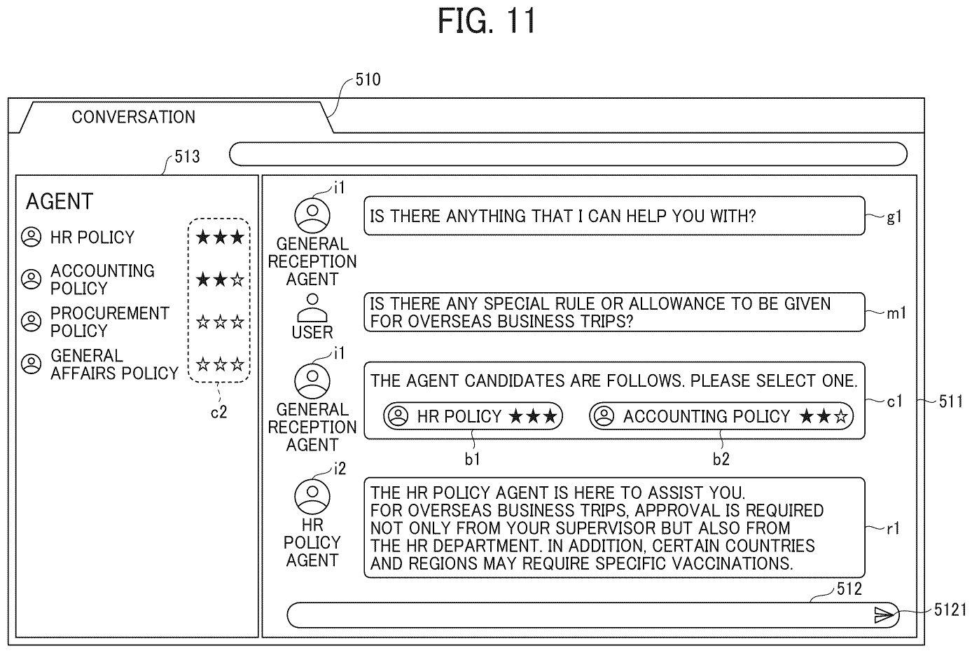

FIG. 11 is a diagram showing an example of a response display. In FIG. 11, parts identical to those in FIG. 10 are labeled with the same reference numerals, and their descriptions are omitted. The interactive screen 510 shown in FIG. 11 has an icon i2 and a response r1 added. A response r1 is the response from the agent to the message ml. Here, an example where the “HR policy” agent is selected is shown. Therefore, the response from the “HR policy” agent (response based on the “HR policy”) is displayed as the response r1. The icon i2 is an icon for the “HR policy” agent. Therefore, the content of the icon i2 is actually different from that of the icon i1.

Furthermore, the user can continue the conversation with the “HR policy” agent by entering a new message into the message input area 512. Alternatively, when a new message is input, steps S201 and subsequent steps in FIG. 7 may be re-executed. In this case, the response candidates will be displayed again. Therefore, the response to the message will be provided by the agent selected from the response candidates.

As described above, according to the first embodiment, the one or more candidate agents that generate responses to the messages from the user are selected and information indicating the selected agent(s) is displayed. If the user selects any one of the displayed agent(s), a response from the selected agent to the message is displayed. Thus, from among multiple automated responders using AI to engage in conversation with the user, the one or more candidate agents capable of generating a response to the user's input message can be selected and displayed. Consequently, for example, an improvement in the accuracy of the response content from the agent can be expected. Furthermore, since the response candidates are narrowed down, the burden on the user regarding agent selection is reduced.

Next, a second embodiment will be described. The second embodiment describes the points differing from the first embodiment. Therefore, points not specifically mentioned are the same as in the first embodiment. In the second embodiment, the operation when any of the response candidates is selected after the response candidate list information shown in FIG. 10 is displayed in step S210 of FIG. 7 differs from that of the first embodiment.

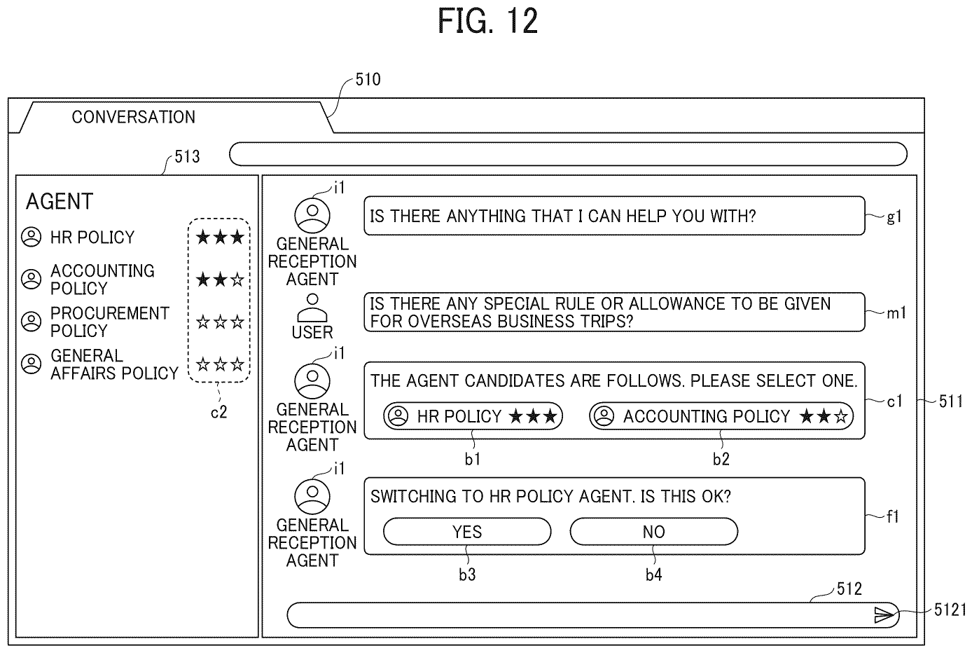

When the user selects the button b1 or the button b2 on the interactive screen 510 shown in FIG. 10, the terminal 20 adds confirmation information to the interactive screen 510 based on the processing procedure embedded in the interactive screen 510 via a script, etc. FIG. 12 is an example of the confirmation information display. In FIG. 12, identical parts to those in FIG. 10 are labeled with the same reference numerals, and their descriptions are omitted. FIG. 12 shows confirmation information f1 added to the interactive screen 510.

The confirmation information includes wording requesting confirmation regarding the correctness of the user's agent selection, along with buttons b3 and b4. If the user believes their selection is correct, they can select the button b3. If the user believes their selection is incorrect, they can select the button b4. If the button b3 is selected, steps S301 and subsequent steps in FIG. 8 are executed. If the button b4 is selected, the terminal 20 clears confirmation information f1 and again prompts the user to select a button from the display the display content c1.

As described above, according to the second embodiment, the user is provided an opportunity to confirm their agent selection operation.

Next, a third embodiment is described. The third embodiment describes points differing from the first embodiment. Therefore, points not specifically mentioned may be the same as in the first embodiment. In the third embodiment, the operation for displaying the target response in step S314 of FIG. 8 differs somewhat from that in the first embodiment. In step S314, the display control unit 135 displays an interactive screen on terminal 20 that is different from interactive screen 510 and includes the target response. That is, in the third embodiment, the interactive screen differs for each agent.

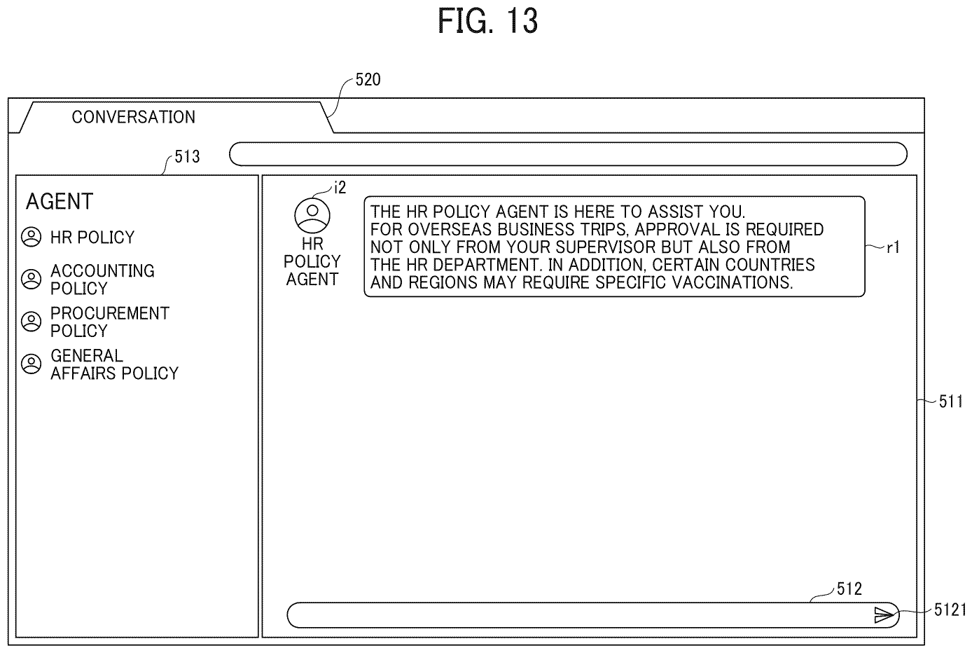

FIG. 13 is a diagram showing an example of the interactive screen displayed for the selected agent. In FIG. 13, the same reference numerals are used for the same parts as in FIG. 12.

The interactive screen 520 shown in FIG. 13 is an interactive screen displayed separately from the interactive screen 510 in FIG. 10. Therefore, the interactive screen 520 (FIG. 13) does not include the greeting message g1, the message ml, or the display contents c1 and c2 contained in the interactive screen 510 (FIG. 10). The interactive screen 520 includes the icon i2 and the response r1. The icon i2 and the response r1 are as described in FIG. 11. Thus, the display control unit 135 displays the response from the selected agent for the target message while simultaneously displaying the interactive screen 520 where that agent becomes the conversation partner.

In this way, by comparing the document data corresponding to each of the multiple agents with the message input by the user, it is possible to present an appropriate agent for the message input by the user.

Next, a fourth embodiment is described. The fourth embodiment describes points differing from the first embodiment. Therefore, points not specifically mentioned may be the same as in the first embodiment. In the fourth embodiment, an example where the terminal 20 displays various screens via a web browser and the information processing device 10 functions as a web server executing web applications is described.

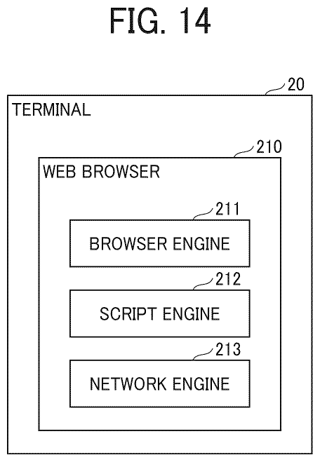

FIG. 14 is a diagram showing an example of the functional configuration of the terminal 20 in the fourth embodiment. In FIG. 14, the terminal 20 has a web browser 210. The web browser 210 is a general-purpose web browser. The web browser 210 includes browser engine 211, a script engine 212, and a network engine 213. The browser engine 211 interprets HTML (Hyper Text Markup Language) data that constitute a web page and CSS (Cascading Style Sheets) data. The browser engine 211 displays the web page. The script engine 212 executes scripts (e.g., JavaScript®) that constitute the web page. The network engine 213 sends HTTP requests and receives HTTP responses.

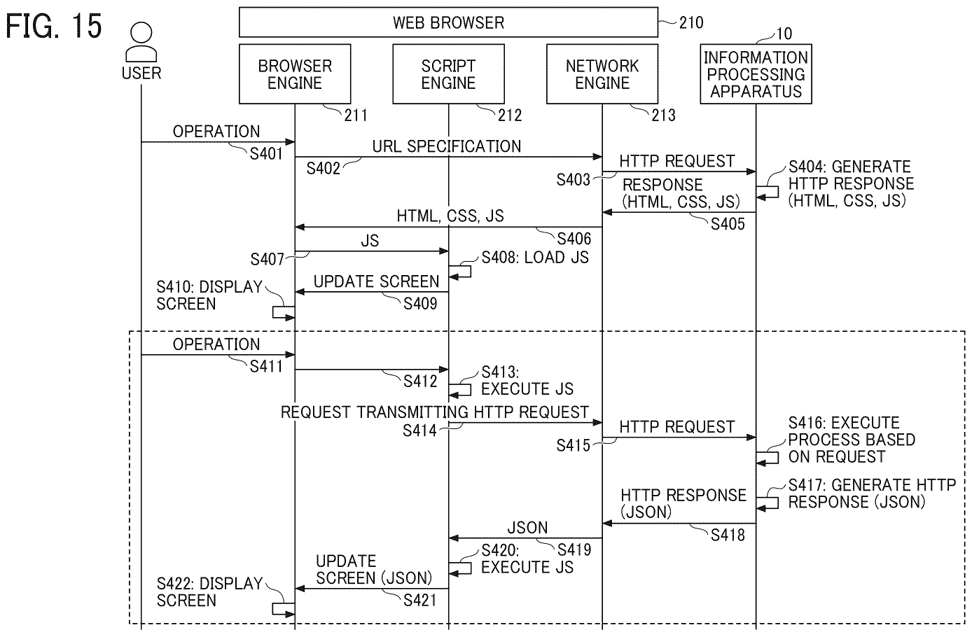

FIG. 15 is a sequence diagram illustrating an example processing procedure for screen transitions in the fourth embodiment.

In response to a user's instruction to display the interactive screen 510 (S401), the browser engine 211 inputs the URL associated with that display instruction-which is the destination URL for the HTTP request to the information processing apparatus 10-into the network engine 213 (S402). The network engine 213 sends an HTTP request to the destination URL (S403). This URL may, for example, be registered in bookmarks of the web browser 210, may be associated with a menu in a menu screen provided by the information processing apparatus 10, or may be directly input by the user. Information indicating this URL may also be searched for by the user using a search engine.

The display control unit 135 of the information processing apparatus 10, in response to the HTTP request, generates an HTTP response corresponding to the web content data (HTML data, CSS data, and script (hereinafter referred to as “JS”) associated with the URL targeted by the HTTP request (S403). This web content is HTTP content for displaying multiple subsequent web pages. Furthermore, JS includes multiple JS that execute processing corresponding to operations for each screen. Subsequently, the display control unit 135 transmits the HTTP response generated in step S404 to the terminal 20 (S405).

Upon receiving the HTTP response, the network engine 213 of the terminal 20 inputs the HTML data, CSS data, and JS contained in the HTTP response to the browser engine 211 (S406). The browser engine 211 inputs the JS received from the network engine 213 into the script engine 212 (S407). The script engine 212 loads the JS (S408) and requests the browser engine 211 to update the screen (S409). The screen update includes displaying a new screen.

Here, the HTTP response generated in step S404 may contain the JS filename rather than the JS entity itself. In this case, in step S408, the script engine 212 accesses an external file based on this filename and downloads the JS. This method involves loading JS as the external file. Next, the browser engine 211 displays the interactive screen 510 of FIG. 9 (S410) based on the HTML data and CSS data.

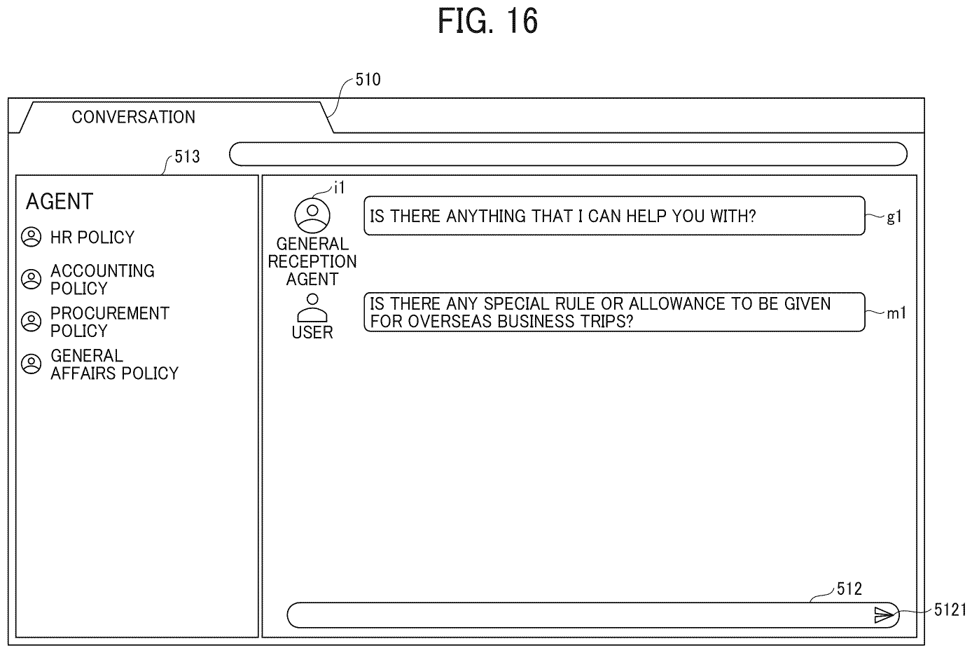

When the user inputs the message into the message input area 512 of the interactive screen 510 (FIG. 9) and clicks the send icon 5121 (S411), the JS that executes the process to display the input message is executed. This causes the display of the interactive screen 510 to change as shown in FIG. 16. In FIG. 16, the message ml, input into the message input area 512 of FIG. 9, is displayed in the conversation display area 511. Subsequently, the content changes as shown in FIG. 16. Subsequently, the browser engine 211 notifies the script engine 212 of the message and the execution of the input (S412).

In response to the notification from the browser engine 211, the script engine 212 executes a JS (one of multiple JSs) that performs the processing to send the input message to the information processing apparatus 10 (S413). By executing this JS, the script engine 212 inputs a request for transmitting the HTTP request corresponding to the input of the message and the message to the network engine 213 (S414). The network engine 213 transmits the HTTP request containing the message to the information processing apparatus 10 (S415).

When the reception unit 131 of the information processing apparatus 10 receives the HTTP request, the information processing apparatus 10 executes the processing requested by the HTTP request (S416). For HTTP requests corresponding to message input on the interactive screen 510 of FIG. 9, steps S202 to S209 of FIG. 7 are executed. As a result, for each agent selected as a response candidate, the response candidate list information including the agent ID and similarity is obtained as the processing result.

Next, the display control unit 135 generates the HTTP response containing JSON (JavaScript Object Notation) describing the response candidate list information as the processing result (S417). Subsequently, the display control unit 135 sends this HTTP response to the terminal 20 (S418). This HTTP response corresponds to step S210 in FIG. 7.

When the network engine 213 of the terminal 20 receives this HTTP response, it inputs the JSON contained in this HTTP response to the script engine 212 (S419). The script engine 212 executes one of the multiple JS, specifically the JS that updates the displayed content of the web page based on the JSON (S420). By executing the JS, the script engine 212, requests the browser engine 211 to update the displayed content of the web page based on the JSON (S421). The browser engine 211 updates the display content of the interactive screen 510 (S422) from the state shown in FIG. 16 to the state shown in FIG. 10 based on the HTML data and CSS data acquired in step S406 and the JSON acquired in step S420.

Subsequently, steps S411 to S422 are repeated in response to user operations on the interactive screen 510. However, the data processed in each step changes.

For example, when the user selects either button b1 or button b2 on the interactive screen 510 (FIG. 10) (S411), the browser engine 211 notifies the script engine 212 of the selection of button b1 or button b2 (S412).

In response to the notification from the browser engine 211, the script engine 212 executes the JS (S413). This JS is one of multiple JSs and performs the processing of sending information corresponding to the selected button to the information processing apparatus 10 (S414). The information corresponding to the selected button is either button identification information identifying the selected button or agent identification information identifying the agent corresponding to the selected button. The network engine 213 transmits the HTTP request corresponding to the selection of button b1 or button b2, which includes the agent ID (selected agent ID) of the agent corresponding to the selected button, to the information processing apparatus 10 (S415). This transmission of the HTTP request corresponds to the transmission of the selected agent ID described in step S301 of FIG. 8.

When the reception unit 131 of the information processing apparatus 10 receives this HTTP request, the information processing apparatus 10 executes the processing requested by this HTTP request (S416). Here, steps S301 to S313 of FIG. 8 are executed, and the response (target response) generated for the message ml of FIG. 10 is obtained as the processing result.

Next, the display control unit 135 generates an HTTP response containing JSON describing the target response, which is the processing result (S417). Subsequently, the display control unit 135 transmits this HTTP response to terminal 20 (S418).

When the network engine 213 of the terminal 20 receives the HTTP response, it inputs the JSON contained in the HTTP response to the script engine 212 (S419). The script engine 212 executes one of the multiple JS, specifically the JS that performs processing to update the displayed content of the web page based on the JSON (S420). By executing the JS, the script engine 212 requests the browser engine 211 to update the displayed content of the web page based on the JSON (S421). The browser engine 211 updates the display content of the interactive screen 510 from the state shown in FIG. 10 to the state shown in FIG. 11 based on the HTML data and CSS data acquired in step S406 and the JSON.

As described above, in the fourth embodiment, a first web page displays a screen (interactive screen 510 in FIG. 9) that accepts message input from the user. A second web page (interactive screen 510 in FIG. 10) that displays information indicating the selected one or more conversational AI. The web content data includes a script that at least performs the processing of transmitting the message input on the first web page to the information processing apparatus 10 and displaying the second web page that displays the information indicating the one or more conversational AI. This web content data is transmitted to the terminal 20 in step S406.

Furthermore, the HTTP request sent by execution of the script on the terminal 20, which is the HTTP request containing the message input on the first web page displayed on the terminal 20 based on the web content data, is received by the receiving unit 131. Upon receiving the HTTP request, the selection unit 132 selects the one or more multiple types of interactive AI corresponding to the message.

Furthermore, the display control unit 135 sends information indicating the selected one or more conversational AI to the terminal 20, included in the HTTP response that is the response to the HTTP request, in order to display the second web page by having terminal 20 execute the script (corresponding to S418 in FIG. 7).

Thus, the web content data, which includes the JS that executes processing corresponding to operations on the first web page, the web page (such as the second web page) after screen transition corresponding to that processing, and the JS that executes processing corresponding to operations on each subsequent web page, is sent to the terminal 20 in a single step in step S405. Since each screen transition is executed by JS, terminal 20 does not need to download the web content data again. As a result, it is possible to expect the resolution of technical issues such as improving the display speed of the second screen, etc., and reducing the communication load during screen transitions.

In the above embodiments, the main functions of the information processing system are shown as being provided by the information processing apparatus 10. However, the terminal 20 may also provide the functions of the information processing apparatus 10.

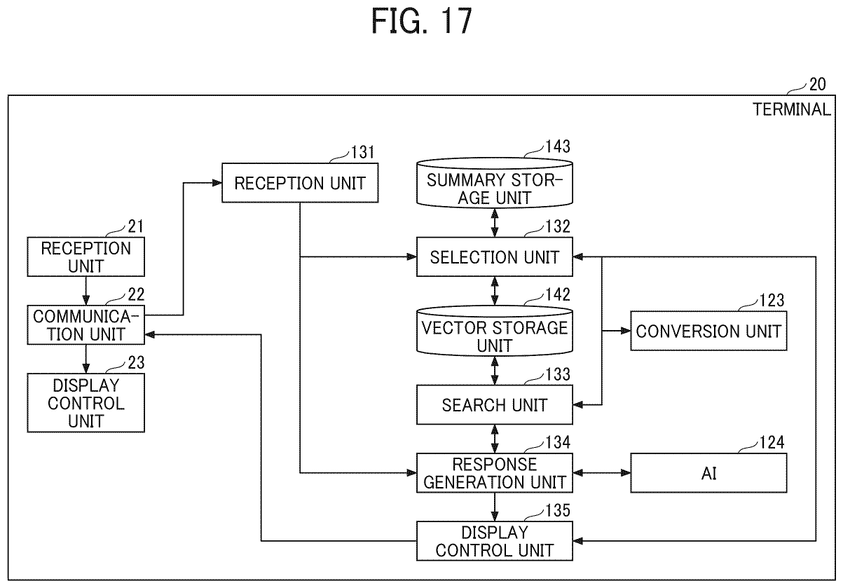

FIG. 17 is a diagram showing an example of the functional configuration of the terminal 20 equipped with the functions of information processing apparatus 10. In FIG. 17, the same reference numerals are used for the same parts as in FIG. 6, and their descriptions are omitted. As described above, each functional configuration has functions similar to those in the functional configuration of FIG. 3 and executes processing similar to that in the sequence diagrams of FIGS. 4, 7, and 8. In FIG. 17, the functions provided by the information processing apparatus 10 in the above embodiments are realized by processing executed by one or more programs installed on the terminal 20 on the CPU of the terminal 20.

Furthermore, the functions shown in FIG. 6 (or FIG. 17) need not be entirely possessed by either the information processing apparatus 10 or the terminal 20; each may possess a subset of the functions. When each possesses a subset of functions, the classification of the group of functions possessed by the information processing apparatus 10 and the group of functions possessed by the terminal 20 is not limited to any specific form. For example, the processing of selecting the agent for the message response candidate (sequence in FIG. 7) may be performed by the functional group possessed by the terminal 20, and the processing of generating the response to the message (sequence in FIG. 8) may be performed by the information processing apparatus 10.

The information processing apparatus 10 may be any apparatus having a communication function, which may be implemented by communication circuitry. The information processing apparatus 10 may be, for example, an output device such as a projector (PJ), an interactive whiteboard (IWB; an electronic whiteboard having a blackboard function enabling mutual communication), or digital signage, or may be a head-up display (HUD), an industrial machine, an imaging device, a sound collecting device, a medical device, a networked home appliance, a laptop personal computer (PC), a mobile phone, a smartphone, a tablet terminal, a game console, a personal digital assistant (PDA), a digital camera, a wearable PC, or a desktop PC.

The apparatuses or devices in the above embodiments are only illustrative of one of several computing environments for implementing the one or more embodiments disclosed herein.

In some embodiments, the information processing apparatus 10 includes multiple computing devices, such as a server cluster. The multiple computing devices are configured to communicate with one another via any type of communication link, including networks or shared memory, and perform the processing disclosed herein. The terminal 20 may also include multiple computing devices configured to communicate with one another.

The following non-limiting examples illustrate aspects of the present disclosure.

According to a first aspect, an information processing system functioning as plurality types of conversational AIs that interact with a user using AI, includes a display control unit and a selection unit. The display control unit that displays a screen for receiving message input from the user. The selection unit selects one or more candidate conversational AIs from the plurality types of conversational Als generating a response to the message based on the message input, when the message input via the screen. The display control unit displays information indicating the selected one or more conversational AI systems. The display control unit displays a response to the message from the selected conversational AI when one of the displayed one or more conversational AIs is selected.

According to a second aspect, in the information processing system of the first aspect, the screen accepts message from the user in a state where the conversational AI has not been selected, and the display control unit displays information indicating the one or more conversational AIs in response to the input of the message to the screen.

According to a third aspect, in the information processing system of the first aspect or second aspect, the plural types of conversational AIs each correspond to a different set of document data. The selection unit selects one or more conversational AIs, for each conversational AI, as response candidates for generating the response to the message, based on the similarity between the set of document data corresponding to that conversational AI and the message.

According to a fourth aspect, in the information processing system of the third aspect, the display control unit displays the response based on the set of document data corresponding to the selected conversational AI for the message input to the screen.

According to a fifth aspect, in the information processing system of the first aspect to fourth aspect, the display control unit, when displaying information indicating the selected one or more conversational AIs, displays the relevance of the one or more conversational AIs to the message in an identifiable manner.

According to a sixth aspect, in the information processing system of the first aspect to fifth aspect, the display control unit further displays a response from the selected the conversational AI to the message while simultaneously displaying an interactive screen where the conversational AI is the conversation partner.

According to a seventh aspect, an information processing apparatus functioning as plurality types of conversational AIs that interact with a user using AI, includes a display control unit and a selection unit. The display control unit that transmits to a terminal display data to display a screen for receiving message input from the user. The selection unit selects one or more candidate conversational AIs from the plurality types of conversational AIs based on the message to generate a response to the message when the message input via the screen. The display control unit transmits displays data to display information indicating the one or more selected conversational Als. The display control unit displays information indicating the selected one or more conversational Als and when one of the displayed one or more conversational Als is selected, the first display control unit displays a response to the message from the selected conversational AI.

According to an eighth aspect, an information processing method executed by a computer functioning as plurality types of conversational AIs that interact with a user using AI, includes a first step of displaying, a second step of selecting, and a third step of displaying. The first step of displaying includes displaying a screen that accepts input of a message from the user. The second step of selecting includes selecting one or more candidate conversational AIs from the plurality types of conversational AIs that generate a response to the message based on the message when input of the message is accepted via the screen. The third step of displaying includes displaying a response to the message from the selected conversational AI when one or more conversational AI is selected.

According to a nineth aspect, a program executed by an information processing apparatus functioning as plurality types of conversational AIs that interact with a user using AI, includes a first step of displaying, a second step of selecting, and a third step of displaying. The first step of displaying includes displaying a screen that accepts input of a message from the user. The second step of selecting includes selecting one or more candidate conversational Als from the plurality types of conversational AIs that generate a response to the message based on the message when input of the message is accepted via the screen. The third step of displaying includes displaying a response to the message from the selected conversational AI when one or more conversational AI is selected.

According to a tenth aspect, an information processing system functioning as plurality types of conversational AIs that interact with a user using AI includes a display control unit and a selection unit. The display control unit that displays a screen for accepting user message input. When inputting the message via the screen is accepted, the selection unit selects one or more candidate dialogue AIs from among the plural types of conversational AIs that generate a response to the message based on the message. The display control unit displays information indicating the selected one or more conversational AIs. When any one of the displayed one or more conversational AIs is selected, the display control unit displays a response from the selected conversational AI to the message. The display control unit transmit web content data for displaying a first web page that includes a screen accepting message input from the user and displaying a second web page that includes information indicating the one or more conversational AI selected. The web content data include a script cause a terminal to transmit the message input on the first web page and a script cause the terminal to display the second web page. The selection unit select the one or more conversational AIs that are candidates of generating the response to the message among plurality types of AI, in response to receiving a HTTP request including the message input on the first webpage. The HTTP request is sent by the execution of the script on the terminal. The display control unit transmit a HTTP response including information indicating the one or more conversational AIs to display the second web page by executing the script.

According to an eleventh aspect, a terminal device functioning as plurality types of conversational AIs that interact with a user using AI, includes a display control unit and a selection unit. The display control unit displays a screen for accepting message input from the user. The selects one or more conversational Als from the plurality types of conversational AIs that are response candidates for generating a response to the message based on the message. The display control unit displays information indicating the selected one or more conversational Als and when one of the displayed one or more conversational AIs is selected, the display control unit displays a response to the message from the selected conversational AI.

According to a twelfth aspect, an information processing system comprising an information processing apparatus functioning as plurality types of conversational AI that interact with a user using AI and a terminal device. The information processing apparatus includes a first display control unit, a selection unit. The first display control unit displays a screen for accepting message input from the user. The selection unit selects one or more conversational Als from the plurality types of conversational AIs that are response candidates for generating a response to the message based on the message. The first display control unit displays information indicating the selected one or more conversational Als and when one of the displayed one or more conversational AIs is selected, the first display control unit displays a response to the message from the selected conversational AI. The terminal includes a reception unit and a second display control unit. The reception unit accepts the message input from the user. The second display unit displays the screen. The second display control unit, when input of the message is accepted via the screen, displays information indicating the selected one or more conversational AIs. The second display control unit when any of the displayed one or more conversational Als is selected, displays a response from the selected conversational AI to the message.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above. Although the embodiments of the present disclosure have been described in detail above, the disclosure is not limited to these specific embodiments. Various modifications and changes are possible within the scope of the essence of the disclosure as described in the appended claims.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a recording medium such as a compact disc-read-only memory (CD-ROM) or DVD, and/or the memory of an FPGA or ASIC.

1. An information processing system comprising:
an information processing apparatus; and
a terminal, wherein
the information processing apparatus includes first circuitry configured to
transmit web content data to the terminal, the web content data including (i) data for causing a display of a first web page for accepting input of a message from a user, (ii) data for causing display of a second web page including one or more conversational AI, (iii) a first script which causes the terminal to transmit the message input in the first web page to the information processing apparatus, and (iv) a second script which causes the terminal to display information indicating the one or more conversational AI;
select the one or more conversational AI as a candidate for generating a response to the message from among a plurality of conversational Als in response to receiving a Hypertext Transfer Protocol (HTTP) request including the message transmitted from the terminal in response to execution of the first script; and
transmit an HTTP response including the information indicating the one or more conversational AI to the terminal;
the terminal includes second circuitry configured to
receive the web content data from the information processing apparatus before the execution of the first script, the web content data including (i) the data for causing the display of the first web page for accepting input of the message from the user, (ii) the data for causing the display of the second web page including the one or more conversational AI, (iii) the first script which causes the terminal to transmit the message input in the first web page to the information processing apparatus, and (iv) the second script which causes the terminal to display information indicating the one or more conversational AI;
display the first web page for accepting input of the message from the user based on the web content data;
receive the message from the user via the first web page;
transmit the HTTP request including the message in response to executing the first script included in the web content data;
receive the HTTP response including the information indicating the one or more conversational AI from the information processing apparatus; and
display the second web page including the one or more conversational AI based on the web content data in response to executing the second script.

2. The information processing system according to claim 1, wherein the second circuitry is configured to:
accept the input of the message from the user when the one or more conversational AI has not been selected; and
display information indicating the one or more conversational AI on a screen of the first web page.

3. The information processing system according to claim 1, wherein:
the one or more conversational AI includes a plurality of types of conversational AI each corresponding to a different set of document data; and
the first circuitry configured to select the one or more conversational AI as the candidate for generating the response to the message based on a similarity between the corresponding set of document data and the message determined for each of the types of conversational AI.

4. The information processing system according to claim 3, wherein the second web page includes the response for the message input to the first web page generated based on the set of document data corresponding to the selected one or more conversational AI.

5. The information processing system according to claim 1, wherein the second web page includes the one or more conversational AI and a degree of relevance of the one or more conversational AI to the message.

6. The information processing system according to claim 1, wherein the second circuitry is configured to display the second web page including a response from the one or more conversational AI and the one or more conversational AI as an interlocutor of the user simultaneously.

7. An information processing method, comprising:
transmitting web content data to a terminal before execution of a first script on the terminal, the web content data including (i) data for causing a display of a first web page for accepting input of a message from a user, (ii) data for causing display of a second web page including one or more conversational AI, (iii) the first script which causes the terminal to transmit the message input in the first web page to the information processing apparatus, and (iv) a second script which causes the terminal to display information indicating the one or more conversational AI;
selecting the one or more conversational AI as a candidate for generating a response to the message from among a plurality of conversational AIs in response to receiving a Hypertext Transfer Protocol (HTTP) request including the message transmitted from the terminal in response to the execution of the first script; and
transmitting an HTTP response including the information indicating the one or more conversational AI to the terminal.

8. The information processing method according to claim 7, wherein the first web page accepts the input of the message from the user when the one or more conversational AI has not been selected.

9. The information processing method according to claim 7, wherein
the one or more conversational AI includes a plurality of types of conversational AI each corresponding to a different set of document data; and
the method includes selecting the one or more conversational AI as the candidate for generating the response to the message based on a similarity between the corresponding set of document data and the message determined for each of the types of conversational AI.

10. The information processing method according to claim 9, wherein the second web page includes the response for the message input to the first web page generated based on the set of document data corresponding to the selected one or more conversational AI.

11. The information processing method according to claim 7, wherein the second web page includes the one or more conversational AI and a degree of relevance of the one or more conversational AI to the message.

12. The information processing method according to claim 7, wherein the second web page includes a response from the one or more conversational AI and the one or more conversational AI as an interlocutor of the user simultaneously.

13. A terminal, comprising:
circuitry configured to
display a first web page for accepting input of a message from a user;
receive the message input by the user;
select one or more conversational AI as a candidate for generating a response to the message from among a plurality of conversational AIs in response to receiving the message;
display a second web page including the one or more conversational AI.

14. The terminal according to claim 13, wherein the circuitry is configured to:
accept the input of the message from the user when the one or more conversational AI has not been selected; and
display information indicating the one or more conversational AI on a screen of the first web page.

15. The terminal according to claim 13, wherein:
the one or more conversational AI includes a plurality of types of conversational AI each corresponding to a different set of document data; and
the circuitry configured to select the one or more conversational AI as the candidate for generating the response to the message based on a similarity between the corresponding set of document data and the message determined for each of the types of conversational AI.

16. The terminal according to claim 15, wherein the second web page includes the response for the message input to the first web page generated based on the set of document data corresponding to the selected one or more conversational AI.

17. The terminal according to claim 13, wherein the second web page includes the one or more conversational AI and a degree of relevance of the one or more conversational AI to the message.

18. The terminal according to claim 13, wherein the circuitry is configured to display the second web page including a response from the one or more conversational AI and the one or more conversational AI as an interlocutor of the user simultaneously.
